(19) United States
(12) Patent Application Publication
(10) Pub. No.: US 2004/0204602 A1
(43) Pub. Date: Oct. 14, 2004

(54) Phenolic group-containing phosphonite compound and process for making the same

(76) Inventors: Erica Lin, Taipei City (TW); Ching-Yie Su, Taipei City (TW)

Correspondence Address: Joseph W. Berenato, III, Liniak, Berenato & White, LLC, Suite 240, 6550 Rock Spring Drive, Bethesda, MD, 20817, US

(21) Appl. No.: 10/618,744

(22) Filed: Jul. 15, 2003

(30) Foreign Application Priority Data
Apr. 9, 2003 (TW) 092108102

(51) Int. Cl. C07F 9/02

(52) U.S. Cl. 558/82

(57) ABSTRACT

A phenolic group-containing phosphonite compound has the following formula (I)

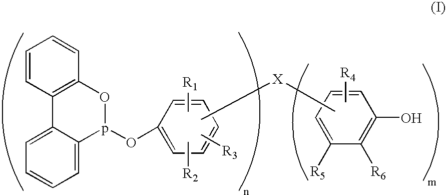

wherein R₁, R₂, R₃, R₄, R₅, and R₆ independently of one another are hydrogen or C₁-C₁₈ alkyl, n and m are integer numbers ranging from 1 to 3, and the sum of n and m ranges from 2 to 4, and X is sulfur or C₁-C₈ alkylene which may be optionally substituted with at least one C₁-C₆ alkyl if the sum of n and m is 2, is a trivalent moiety of C₃-C₇ aliphatic group if the sum of n and m is 3, and is a tetravalent moiety of C₄-C₁₀ aliphatic group if the sum of n and m is 4.

### CROSS-REFERENCE TO RELATED APPLICATION

This application claims priority of Taiwanese application No. 092108102, filed on Apr. 9, 2003.

### BACKGROUND OF THE INVENTION

1. Field of the Invention

This invention relates to a phosphonite compound, more particularly to a phenolic group-containing phosphonite compound and to the process for making the same.

2. Description of the Related Art

Stabilizers, such as primary antioxidants and secondary antioxidants, are used for preventing degradation of polymers when the latter is exposed to light or heat. Typical examples of the primary antioxidants are sterically hindered phenols or secondary aromatic amines which are capable of undergoing fast reactions with peroxy radicals formed in the polymers so as to terminate undesired free radical chain reaction in the polymers. Typical examples of the secondary antioxidants are sulfur compounds and phosphites which can react with hydroperoxides formed in the polymers so as to form non-radical products. It is known in the art that synergistic effects are observed when the primary and secondary oxidants are combined. However, the thermal stability of the combinations is still poor due to low molecular weight of the aforesaid compounds. For instance, the mixture of tetrakismethylene (3,5-di-t-butyl-4-hydroxyhydrocinnamate)methane (a phenolic compound) and tris(2,4-di-t-butylphenyl)phosphite (a phosphite compound) blended in a ratio of 1:4, which can obtain good anti-oxidation effect, is poor in thermal stability due to the tendency of decomposition of the aforesaid phosphite compound at elevated temperatures. The phosphite compound completely decomposes at a temperature of about 350° C.

U.S. Pat. Nos. 4,185,006, 4,276,232, 4,380,515, and 4,661,440 disclose phosphonite stabilizers that have larger molecular weight than those of the aforesaid phenolic compounds and phosphites, which renders the phosphonite stabilizers to have better thermal stability than those of the aforesaid phenolic compounds and phosphites. The disclosures of the aforesaid U.S. Patents are incorporated herein by reference.

### SUMMARY OF THE INVENTION

The object of the present invention is to provide a phenolic group-containing phosphonite compound that not only combines the functions of the aforesaid phenolic compounds and phosphites, but also possesses better thermal stability over the aforesaid phenolic compounds and phosphites.

According to one aspect of the present invention, there is provided a phenolic group-containing phosphonite compound of formula (I)

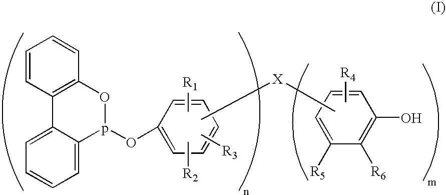

wherein

R₁, R₂, R₃, R₄, R₅, and R₆ independently of one another are hydrogen or C₁-C₁₈ alkyl,

n and m are integer numbers ranging from 1 to 3, and the sum of n and m ranges from 2 to 4, and

wherein

X, if the sum of n and m is 2, is sulfur or C₁-C₈ alkylene which may be optionally substituted with at least one C₁-C₆ alkyl,

X, if the sum of n and m is 3, is a trivalent moiety of C₃-C₇ aliphatic group, and

X, if the sum of n and m is 4, is a tetravalent moiety of C₄-C₁₀ aliphatic group.

According to another aspect of the present invention, there is provided a polymer composition that comprises a polymer material and the compound of formula (I).

According to yet another aspect of the present invention, there is provided a process for preparing the compound of formula (I). The process comprises the step of reacting a phosphonite compound of formula (A)

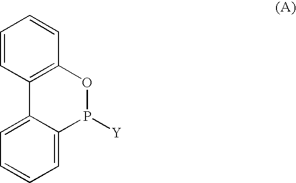

wherein Y is halogen, with a phenolic compound of formula (B)

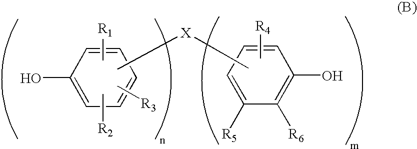

wherein n, m, R₁, R₂, R₃, R₄, R₅, R₆, and X have the same meanings as defined in the forgoing, in a non-acidic reaction condition.

### DETAILED DESCRIPTION OF THE PREFERRED EMBODIMENT

This invention provides a phenolic group-containing phosphonite compound that can serve as a stabilizer for polymers, that combines the functions of the aforesaid phenolic compounds and phosphites, which are capable of reacting with peroxy radicals and hydroperoxides, respectively, and that possesses better thermal stability over the aforesaid phenolic compounds and phosphites.

The phenolic group-containing phosphonite compound has the following formula (I)

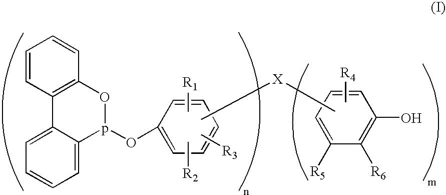

wherein

R₁, R₂, R₃, R₄, R₅, and R₆ independently of one another are hydrogen or C₁-C₁₈ alkyl,

n and m are integer numbers ranging from 1 to 3, and the sum of n and m ranges from 2 to 4, and

wherein

X, if the sum of n and m is 2, is sulfur or C₁-C₈ alkylene which may be optionally substituted with at least one C₁-C₆ alkyl,

X, if the sum of n and m is 3, is a trivalent moiety of C₃-C₇ aliphatic group, and

X, if the sum of n and m is 4, is a tetravalent moiety of C₄-C₁₀ aliphatic group.

The phenolic group-containing phosphonite compound of formula (I) can be prepared through esterification or transesterification reactions, for example, by reacting a phosphonite compound of formula (A)

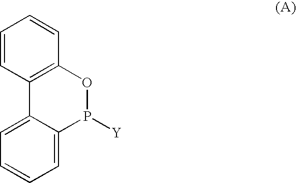

wherein Y is halogen, with a phenolic compound of formula (B)

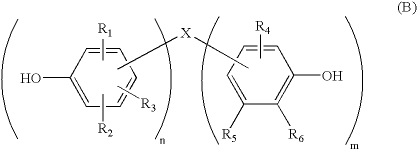

wherein n, m, R₁, R₂, R₃, R₄, R₅, R₆, and X have the same meanings as defined in the forgoing, in a non-acidic reaction condition. The aforesaid reaction can be represented as follows

n(A)+(B)→(I)+nHY

Preferably, the reaction is carried out in the presence of a base in an inert solvent. The base is preferably selected from the group consisting of amine, triethylamine, pyridine, N,N′-dimethylaniline, sodium carbonate, and the mixtures thereof. The inert solvent is preferably an aprotic solvent, such as petroleum ether, toluene, xylene, methyl-ethyl ketone, acetonitrile, and ethyl acetate. Amine can also be used as solvent.

In a preferred embodiment, the phenolic group-containing phosphonite compound of formula (I) is 6-(4,4′-butylidene-2-t-butyl-5-methylphenol-2′-t-butyl-5′-methylphenoxy)dibenz[c,e]-[1,2]oxaphosphorine, i.e., n and m are 1, X is propylmethylene, R₁ and R₄ are methyl, R₂ and R₆ are t.butyl, and R₃ and R₅ are hydrogen. The structure of the preferred embodiment is as follows

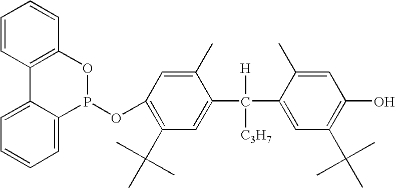

The phenolic compound of formula (B) for preparing 6-(4,4′-butylidene-2-t-butyl-5-methylphenol-2′-t-butyl-5′-methylphenoxy)dibenz[c,e]-[1,2]oxaphosphorine can be one of the following compounds (b1), (b2), (b3).

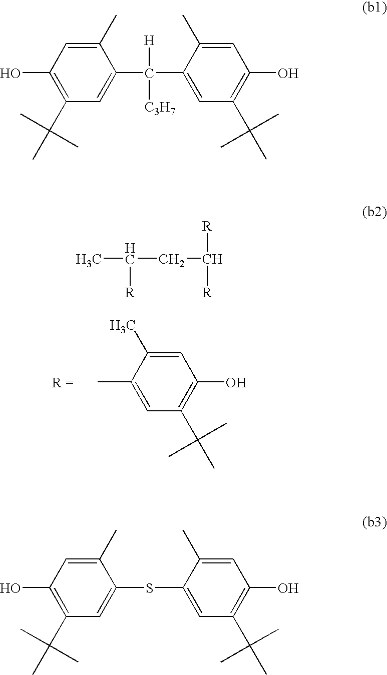

The thus formed compound 6-(4,4′-butylidene-2-t-butyl-5-methylphenol-2′-t-butyl-5′-methylphenoxy)dibenz[c,e]-[1,2]oxaphosphorine shows excellent thermal stability. In a thermal test with an increase in temperature, the compound is only partially decomposed (up to 48% is not decomposed) when the temperature reaches about 400° C. (the aforesaid phenolic compounds and phosphites are completely decomposed under this temperature).

The present invention is also related to a polymer composition that comprises a polymer material and the phenolic group-containing phosphonite compound of formula (I). The polymer material may be polyolefins (for example polyethylene and polypropylene) and its copolymers, polystyrene and its copolymers (such as acrylonitrile-butadiene-styrene), polyamide, linear polyester, polyurethane, polycarbonate, elastomer, and polyvinyl chloride. The phenolic group-containing phosphonite compound of formula (I) is preferably in an amount of from 0.005 to 5 wt % of the polymer composition, and more preferably from 0.05 to 0.5 wt % of the polymer composition.

### EXAMPLES AND COMPARATIVE EXAMPLES

The present invention will be described in more detail in the following Examples.

### A. Preparation of 6-(4,4′-butylidene-2-t-butyl-5-methylphenol-2′-t-butyl-5′-methylphenoxy)dibenz[c,e]-[1,2]oxaphosphorine

46.95 g (0.2 mole) of 6-chloro-dibenz[c,e][1,2]oxaphosphorine, 84.26 g of 4,4′-butylidenebis(2-t-butyl-5-methylphenol), 120 ml triethylamine and 350 ml toluene were added into a reactor. Reaction was carried out at a temperature of about 80° C. for 18 hours. After the reaction, the reaction mixture was subjected to filtration and crystallization to obtain a crystalline product that has a melting point 75±5° C.

### B. Materials for Preparation of Stabilizers

(a): 6-(4,4′-butylidene-2-t-butyl-5-methylphenol-2′-t-butyl-5′-methylphenoxy)dibenz[c,e]-[1,2]oxaphosphorine

(b): tetrakismethylene(3,5-di-t-butyl-4-hydroxyhydrocinnamate)methane

(c): octadecyl 3-(3′,5′-di-t-buty-4′-hydroxy-phenyl)propionate

(d): tris(2,4-di-t-butylphenyl)phosphite

(e): cyclic neopentanetetrayl bis(octadacyl phosphite)

### C. Stabilizers (Examples 1-7 and Comparative Examples 1-3)

The stabilizers shown in Table 1 were prepared using different combinations of the materials listed above.

TABLE 1

| Example | Material | Weight Ratio |
|---|---|---|
| 1 | (a) | — |
| 2 | (a)/(d) | 1:1 |
| 3 | (a)/(b) | 1:1 |
| 4 | (a)/(d)/(b) | 1:1 |
| 5 | (a)/(e) | 1:1 |
| 6 | (a)/(c) | 2:1:1 |
| 7 | (a)/(c)/(e) | 2:1:1 |
| Comparative Example | Material | Ratio |
| 1 | (c)/(d) | 1:4 |
| 2 | (b)/(d) | 1:2 |
| 3 | (c)/(e) | 1:2 |

### D. Polymer Compositions (Examples 8-23 and Comparative Examples 4-10)

The polymer compositions shown in Table 2 are combinations of polypropylene (PP) and the stabilizers shown in Table 1. Each polymer composition was prepared by blending the stabilizer and the polymer in a single screw extruder under a temperature of less than 230° C. A small amount (1200 ppm) of additive (calcium sterate) was added into each polymer composition.

TABLE 2
(PP Polymer)

| Example | stabilizer | Amount of stabilizer, ppm |
|---|---|---|
| 8 | Example 1 | 500 |
| 9 | Example 1 | 1000 |
| 10 | Example 1 | 2000 |
| 11 | Example 2 | 1000 |
| 12 | Example 3 | 1000 |
| 13 | Example 4 | 1000 |
| Comparative Example | stabilizer | mount of stabilizer, ppm |
| 4 | Comparative | 500 |
| | Example 2 | |
| 5 | Comparative | 1000 |
| | Example 2 | |

The polymer compositions shown in Table 3 are combinations of polyethylene (PE) and the stabilizers shown in Table 1. Each polymer composition was prepared by blending the stabilizer and the polymer in the single screw extruder under a temperature of less than 200° C. A small amount (1200 ppm) of additive (calcium sterate) was added into each polymer composition.

TABLE 3
(PE Polymer)

| | | Amount of |
|---|---|---|
| Example | stabilizer | stabilizer, ppm |
| 14 | Example 1 | 500 |
| 15 | Example 1 | 1000 |
| 16 | Example 1 | 2000 |
| 17 | Example 2 | 1000 |
| 18 | Example 3 | 1000 |
| 19 | Example 4 | 1000 |
| | | mount of |
| Comparative Example | stabilizer | stabilizer, ppm |
| 6 | Comparative Example 1 | 500 |
| 7 | Comparative Example 1 | 1000 |
| 8 | Comparative Example 2 | 500 |
| 9 | Comparative Example 2 | 1000 |

The polymer compositions shown in Table 4 are combinations of acrylonitrile-butadiene-styrene (ABS) and the stabilizers shown in Table 1. Each polymer composition was prepared by blending the stabilizer and the polymer in the single screw extruder under a temperature of about 220° C.

TABLE 4
(ABS Polymer)

| | stabilizer | Amount of stabilizer, ppm |
|---|---|---|
| Example | | |
| 20 | Example 1 | 1000 |
| 21 | Example 5 | 1000 |
| 22 | Example 6 | 1000 |
| 23 | Example 7 | 1000 |
| Comparative | | |
| Example | | |
| 10 | Comparative Example 3 | 100 |

### E. Results

Each polymer composition shown in Tables 2 and 3 was measured for yellowing (b=+yellow/−blue, higher b value means more severe yellowing), and Melt index (MI) (higher MI value means more severe material degradation). The results are respectively shown in Tables 5 and 6 for polymer PP and Tables 7 and 8 for polymer PE. A spectrophotometer was used for measuring the yellowing and Yellowness Index of the polymer compositions.

TABLE 5
(PP polymer)

| | | b value, after | | |
|---|---|---|---|---|
| | b value, prior to | | third | fifth |
| | extrusion | first extrusion | extrusion | extrusion |
| Example | | | | |
| blank | −0.75 | −0.11 | 1.22 | 2.54 |
| 8 | −1.82 | −1.68 | −1.05 | −0.91 |
| 9 | −1.85 | −1.72 | −1.34 | −1.07 |
| 10 | −1.90 | −1.82 | −1.68 | −1.52 |
| 11 | −1.80 | −1.70 | −1.08 | −0.92 |
| 12 | −1.78 | −1.70 | −1.12 | −0.95 |
| 13 | −1.80 | −1.71 | −1.15 | −0.97 |
| Comparative | | | | |
| Example | | | | |
| 2 | −1.52 | −1.02 | −0.31 | 0.25 |
| 2 | −1.60 | −1.19 | −0.76 | −0.27 |

TABLE 6
(PP polymer)

| | | MI value, after | | |
|---|---|---|---|---|
| | MI value, prior to | first | third | fifth |
| Example | extrusion | extrusion | extrusion | extrusion |
| blank | 4.5 | 5.1 | 6.2 | 8.3 |
| 8 | 3.2 | 3.3 | 3.6 | 4.0 |
| 9 | 3.0 | 3.1 | 3.2 | 3.4 |
| 10 | 3.0 | 3.1 | 3.1 | 3.2 |
| 11 | 3.1 | 3.2 | 3.4 | 3.8 |
| 12 | 3.1 | 3.2 | 3.4 | 3.7 |
| 13 | 3.0 | 3.2 | 3.5 | 3.7 |
| Comparative | b value, prior to | first | third | fifth |
| Example | extrusion | extrusion | extrusion | extrusion |
| 2 | 4.2 | 4.8 | 5.8 | 6.5 |
| 2 | 4.2 | 4.6 | 5.3 | 5.6 |

TABLE 7
(PE polymer)

| | b value, after | | |
|---|---|---|---|
| b value, prior to | first | third | fifth |
| extrusion | extrusion | extrusion | extrusion |

| | | | | |
|---|---|---|---|---|
| Example | | | | |
| blank | −0.85 | 1.05 | 3.85 | 4.2 |
| 14 | −2.32 | −2.25 | −1.66 | −1.0.87 |
| 15 | −2.13 | −2.21 | −1.86 | −1.07 |
| 16 | −2.25 | −2.22 | −2.02 | −1.68 |
| 17 | −2.26 | −2.21 | −1.75 | −1.00 |
| 18 | −2.18 | −2.20 | −1.76 | −1.02 |
| 19 | −2.24 | −2.21 | −1.8 | −1.05 |
| Comparative | | | | |
| Example | | | | |
| | −1.29 | −1.03 | −0.4 | −0.2 |
| 7 | −1.51 | −0.87 | 0.77 | 1.66 |
| 8 | −1.81 | −1.69 | −0.96 | −0.78 |
| 9 | −2.48 | −2.12 | −1.02 | −0.02 |

TABLE 8
(PE polymer)

| | | MI value, after | | |
|---|---|---|---|---|
| | MI value, prior to | first | third | fifth |
| Example | extrusion | extrusion | extrusion | extrusion |
| blank | 0.25 | 0.19 | 0.12 | 0.10 |
| 14 | 0.25 | 0.25 | 0.23 | 0.21 |
| 15 | 0.25 | 0.26 | 0.26 | 0.25 |
| 16 | 0.25 | 0.26 | 0.25 | 0.25 |
| 17 | 0.25 | 0.25 | 0.24 | 0.23 |
| 18 | 0.25 | 0.25 | 0.25 | 0.26 |
| 19 | 0.25 | 0.25 | 0.24 | 0.25 |
| Comparative | b value, prior to | first | third | fifth |
| Example | extrusion | extrusion | extrusion | extrusion |
| 6 | 0.25 | 0.20 | 0.15 | 0.14 |
| 7 | 0.25 | 0.25 | 0.23 | 0.21 |
| 8 | 0.25 | 0.21 | 0.18 | 0.16 |
| 9 | 0.25 | 0.25 | 0.23 | 0.20 |

Each polymer composition shown in Table 4 was measured for Yellowness Index (YI) (higher YI value means more severe yellowing) prior to and after curing in an oven under a temperature of 180° C. for 2 hours. The difference (ΔYI) between initial YI and YI after curing was calculated. The results are shown in Table 9.

TABLE 9
(ABS)

YI value after extrusion

| | | YI after | |
|---|---|---|---|
| | Initial YI | curing | Δ YI |
| Example | | | |
| blank | 14 | 75 | 61 |
| 20 | 11 | 52 | 41 |
| 21 | 12 | 57 | 45 |
| 22 | 12 | 58 | 46 |
| 23 | 11 | 55 | 44 |
| | | YI after | |
| | Initial YI | curing | Δ YI |
| Comparative | | | |
| Example | | | |
| 10 | 12 | 60 | 48 |

The results (Tables 5 to 9) show that the phenolic group-containing phosphonite compound of formula (I) combines the functions of the aforesaid phenolic compounds and phosphites, and possesses better thermal stability over the aforesaid phenolic compounds and phosphites.

With the invention thus explained, it is apparent that various modifications and variations can be made without departing from the spirit of the present invention.

1. A phenolic group-containing phosphonite compound of formula (I) 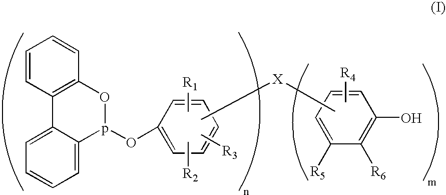
wherein
R₁, R₂, R₃, R₄, R₅, and R₆ independently of one another are hydrogen or C₁-C₁₈ alkyl,
n and m are integer numbers ranging from 1 to 3, and the sum of n and m ranges from 2 to 4; and
wherein
X, if the sum of n and m is 2, is sulfur or C₁-C₈ alkylene which may be optionally substituted with at least one C₁-C₆ alkyl,
X, if the sum of n and m is 3, is a trivalent moiety of C₃-C₇ aliphatic group, and
X, if the sum of n and m is 4, is a tetravalent moiety of C₄-C₁₀ aliphatic group.

2. The compound of formula (I) as defined in claim 1, wherein n and m are 1, and X is C₁-C₆ alkyl substituted alkylene.

3. The compound of formula (I) as defined in claim 2, wherein X is propylmethylene, R₁ and R₄ are methyl, R₂ and R₆ are t-butyl, and R₃ and R₅ are hydrogen.

4. A polymer composition stabilized against oxygen, light, and heat, comprising:
a polymer material; and
a phenolic group-containing phosphonite compound of formula (I) 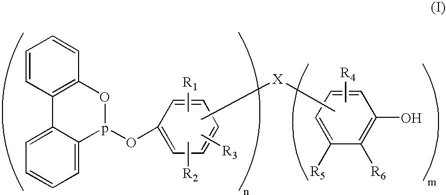
wherein
R₁, R₂, R₃, R₄, R₅, and R₆ independently of one another are hydrogen or C₁-C₁₈ alkyl,
n and m are integer numbers ranging from 1 to 3, and the sum of n and m ranges from 2to 4;
wherein
X, if the sum of n and m is 2, is sulfur or C₁-C₈ alkylene which may be optionally substituted with at least one C₁-C₆ alkyl,
X, if the sum of n and m is 3, is a trivalent moiety of C₃-C₇ aliphatic group, and
X, if the sum of n and m is 4, is a tetravalent moiety of C₄-C₁₀ aliphatic group.

5. The polymer composition as defined in claim 4, wherein n and m are 1, and X is C₁-C₆ alkyl substituted alkylene.

6. The polymer composition as defined in claim 5, wherein X is propylmethylene.

7. The polymer composition as defined in claim 4, wherein X is sulfur.

8. The polymer composition as defined in claim 4, wherein said polymer material is selected from the group consisting of polyolefins, polystyrene, and styrene copolymers.

9. The polymer composition as defined in claim 4, wherein said polymer material is selected from the group consisting of polypropylene, polyethylene, and mixtures thereof.

10. The polymer composition as defined in claim 4, wherein said polymer material is acrylonitrile-butadiene-styrene copolymer.

11. The polymer composition as defined in claim 4, further comprising a phosphorus compound selected from the group consisting of tetrakismethylene(3,5-di-t-butyl-4-hydroxyhydrocinnamate)methane, octadecyl 3-(3′,5′-di-t-butyl-4′-hydroxy-phenyl)propionate, and mixtures thereof.

12. The polymer composition as defined in claim 4, further comprising a phosphite compound selected from the group consisting of tris(2,4-di-t-butylphenyl)phosphite, cyclic neopentanetetrayl bis(octadecyl phosphite), and mixtures thereof.

13. The polymer composition as defined in claim 12, further comprising a phosphorus compound selected from the group consisting of tetrakismethylene(3,5-di-t-butyl-4-hydroxyhydrocinnamate)methane, octadecyl 3-(3′,5′-di-t-butyl-4′-hydroxy-phenyl)propionate, and mixtures thereof.

14. The polymer composition as defined in claim 4, wherein said phenolic group-containing phosphonite compound is in an amount of from 0.05 to 0.5 wt % of said polymer composition.

15. A process for preparing the compound of formula (I) as defined in claim 1, comprising the steps of:
reacting a phosphonite compound of formula (A) 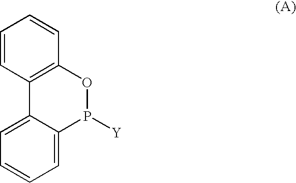
wherein Y is halogen, with a phenolic compound of formula (B) 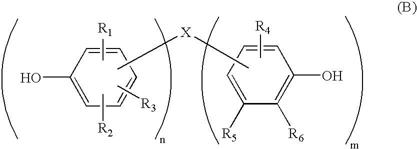
wherein n, m, R₁, R₂, R₃, R₄, R₅, R₆, and X have the same meanings as defined in claim 1, in a non-acidic reaction condition.

16. The process as defined in claim 15, wherein n and m are 1, and X is C₁-C₆ alkyl substituted alkylene.

17. The process as defined in claim 15, wherein X is propylmethylene, R₁ and R₄ are methyl, R₂ and R₆ are t-butyl, and R₃ and R₅ are hydrogen.

18. The process as defined in claim 15, wherein the reaction is carried out in the presence of a base in an inert solvent.
